(19) United States
(12) Patent Application Publication
(10) Pub. No.: US 2017/0324576 A1
(43) Pub. Date: Nov. 9, 2017

(54) MASTER MODULE

(71) Applicant: Hewlett-Packard Development Company, L.P., Houston, TX (US)

(72) Inventors: Alok Jain, Bangalore (IN); Niraj Agrawal, Bangalore (IN)

(21) Appl. No.: 15/329,502

(22) PCT Filed: Jul. 28, 2014
(86) PCT No.: PCT/US2014/048398

§ 371 Date: Jan. 26, 2017

(51) Int. Cl. H04L 12/28; G06F 9/50; G06F 9/455

(52) U.S. Cl. CPC H04L 12/2803; G06F 9/455; G06F 9/50

(57) ABSTRACT

A master module includes a processor and a memory. The memory includes executable code that, when executed by the processor: provides a number of computational resources to a number of device modules. The device modules are vendor-sourced device modules. The vendors are entities that provide services associated with an internet-of-things device.

### BACKGROUND

The Internet of Things (IoT) refers to identifiable electronic devices and their respective virtual representations in an internet or internet-like structure. The devices in the IoT may be equipped with identifiers, and may be managed by computing devices operated by end users or vendors of the IoT devices. The devices within the IoT may be tagged in order to identify individual devices within the IoT. Tagging may be achieved through radio-frequency identification (RFID), near field communication, barcodes, QR codes, digital watermarking, or other forms of device identification and tagging. Thus, IoT provides advanced connectivity of devices, systems, and services with machine-to-machine communications using a number of protocols, domains, and applications.

The IoT provides several advantages to users of the devices in the IoT such as the ability to remotely alter or interact with the devices, provide instant and ceaseless inventory control, and provide an end user with information associated with the IoT enabled device, among many other advantages. Vendors of IoT connected devices and services may provide for a purchaser of the devices and/or services with the ability to interact or manage the devices and/or services. However, with the growing number of devices and services being offered by the vendors, it has become difficult to provide a uniform platform with which all devices and/or services may be interacted. Further, all the individual vendor devices may not collectively provide a level of modularity that a user may desire. Still further, these individual vendor devices do not provide centralized security and firewall protections, or provide other centralized computing resources.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a diagram of a modular device system including a master module and a number of device modules, according to one example of the principles described herein.

FIG. 2 is a diagram of the master module of FIG. 1, according to one example of the principles described herein.

FIG. 3 is a diagram of a device module of FIG. 1, according to one example of the principles described herein.

FIG. 4 is a diagram of the two modular device systems of FIG. 1 used in a computing network, according to one example of the principles described herein.

FIG. 5 is a flowchart showing a method of providing access to an internet-of-things (IoT) device, according to one example of the principles described herein.

Throughout the drawings, identical reference numbers designate similar, but not necessarily identical, elements.

### DETAILED DESCRIPTION

The present systems and methods provide for a master module communicatively stackable with a number of device modules. The master module provides computing resources such as electrical power, processing power, memory, network connectivity, security, or combinations thereof. The device modules may be vendor-sourced or vendor-produced device modules that are configured to operate devices that are included in the internet-of-things. In this manner, a user may purchase the master module and any number of device modules according to his or her needs. For example, the vendors may produce device modules that are configured to control home security systems, internet-enabled TV modules, modems, routers, data storage devices, VOIP telephone units, and household appliances, among many other devices considered part of the internet-of-things.

As used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

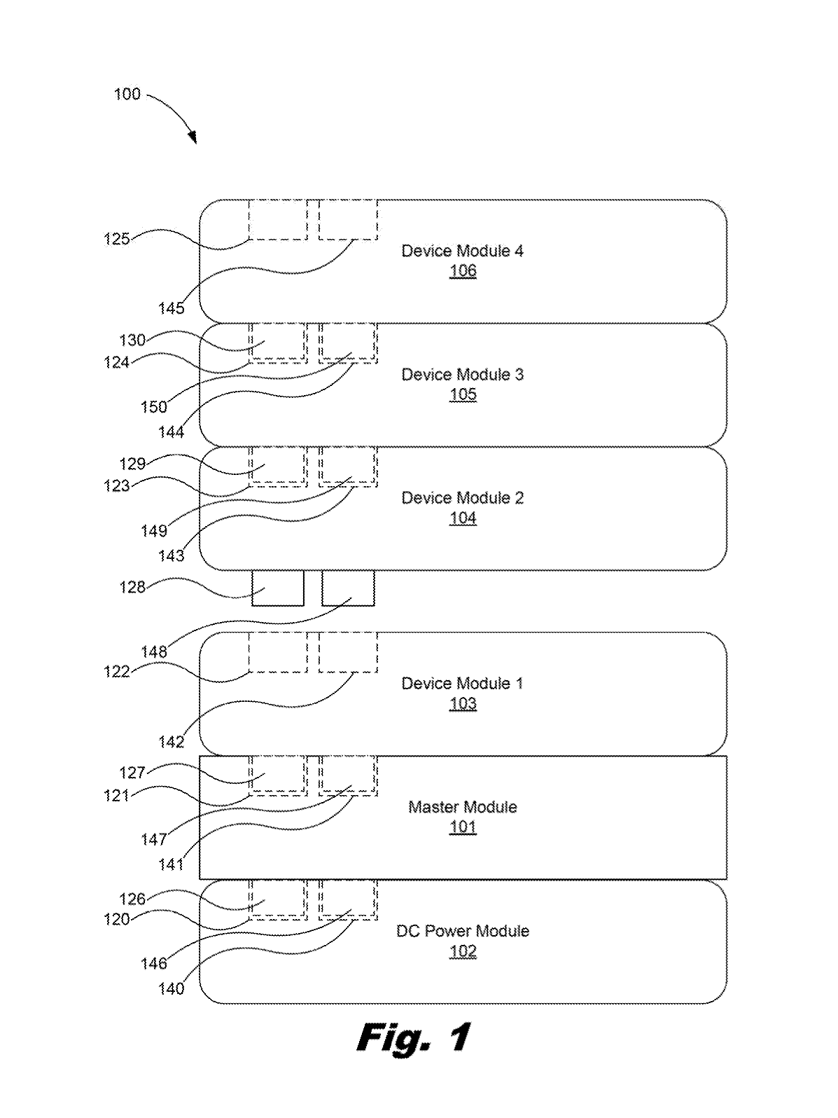

FIG. 1 is a diagram of a modular device system (100) including a master module (101) and a number of device modules (103, 104, 105, 106), according to one example of the principles described herein. The master module (101) of the modular device system (100) provides a number of computing resources to the device modules (103, 104, 105, 106) as will be described in more detail below. Although four device modules (103, 104, 105, 106) are depicted in FIG. 1, any number of device modules (103, 104, 105, 106) may be communicatively and electrically coupled to the master module (101). The modular device system (100) may further include a direct current (DC) power module (102) to provide electrical power to the master module (101) of the modular device system (100) in place of or in addition to an alternating current (AC) power source provided to the master module (101) of the modular device system (100).

In one example, the modular device system (100) may comprise a stack of devices including the master module (101), the DC power module (102), and a number of device modules (103, 104, 105, 106). As depicted in FIG. 1, each device within the modular device system (100) comprises a female power connector (120, 121, 122, 123, 124, 125) for receiving a number of corresponding male power connectors (126, 127, 128, 129, 130) from a device module (103, 104, 105, 106) placed on top. Electrical power is provided from the master module (101) and its AC power source and/or the DC power module (102) to the device modules (103, 104, 105, 106) through the female power connectors (120, 121, 122, 123, 124, 125) and male power connectors (126, 127, 128, 129, 130). In one example, the master module (101) controls and provides for power consumption throughout the module device system (100). In one example, the female (120, 121, 122, 123, 124, 125) and male (126, 127, 128, 129, 130) power connectors are coaxial connectors. However, the female (120, 121, 122, 123, 124, 125) and male (126, 127, 128, 129, 130) power connectors may be any type of connector that transmits power.

As depicted in FIG. 1, coupling of a device module (103, 104, 105, 106) on top of the master module (101) or on top of another device module (103, 104, 105, 106) results in the device module (103, 104, 105, 106) placed on top consuming the power coupling of the device module (103, 104, 105, 106) or master module (101) below. Thus, the male power connectors (126, 127, 128, 129, 130) coupling with the female power connectors (120, 121, 122, 123, 124, 125) provides transmission of power throughout the stack formed by the devices (101, 102, 103, 104, 105, 106) within the modular device system (100). Thus, a first device module (103, 104, 105, 106) or the master module (101) exposes a female power connector (120, 121, 122, 123, 124, 125) on the top thereof for consumption by a device module (103, 104, 105, 106) placed thereon.

As depicted in FIG. 1, each device within the modular device system (100) comprises a female communication connector (140, 141, 142, 143, 144, 145) for receiving a number of corresponding male communication connectors (146, 147, 148, 149, 150) from a device module (103, 104, 105, 106) placed on top. Communication is transmitted between the master module (101) and the device modules (103, 104, 105, 106) through the female communication connectors (140, 141, 142, 143, 144, 145) and male communication connectors (146, 147, 148, 149, 150). In one example, the master module (101) controls communications throughout the module device system (100). In another example, the device modules (103, 104, 105, 106) and the master module (101) freely communicate via the female communication connectors (140, 141, 142, 143, 144, 145) and male communication connectors (146, 147, 148, 149, 150) with each other. In one example, the female (140, 141, 142, 143, 144, 145) and male (146, 147, 148, 149, 150) communication connectors are universal serial bus (USB) connectors. However, the female (140, 141, 142, 143, 144, 145) and male (146, 147, 148, 149, 150) communication connectors may be any type of connector that transmits signals.

Further, as depicted in FIG. 1, coupling of a device module (103, 104, 105, 106) on top of the master module (101) or another device module (103, 104, 105, 106) results in the device module (103, 104, 105, 106) placed on top consuming the communication coupling of the device module (103, 104, 105, 106) or master module (101) below through the male communication connectors (146, 147, 148, 149, 150) coupling with the female communication connectors (140, 141, 142, 143, 144, 145). Thus, a first device module (103, 104, 105, 106) or the master module (101) exposes a female communication connector (140, 141, 142, 143, 144, 145) on the top thereof for consumption by a device module (103, 104, 105, 106) placed thereon.

In this manner, the device module (103, 104, 105, 106) may be stacked on the master module (101), and the DC power module (102) may be coupled to the bottom of the master module (101). The ability to stack devices on each other provides for all devices within the modular device system (100) to exist in a single footprint. Further, the separate electrical and communication interfaces between the master module (101), DC power module (102), and device modules (103, 104, 105, 106) creates a separation of power and communications due to some types of communication ports such as USB having electrical limitations such as being able to carry a maximum amount of current. Still further, as will be described in more detail below, the hardware structural design of FIG. 1 and the remainder of the figures provide the benefits of modularity and extensibility, while providing standardization of dimensions for vendor-sourced IoT modules.

In one example, the DC power module (102) is a battery. In this example, the battery may be a rechargeable battery or a non-rechargeable battery. In this manner, the battery may provide mobility and portability for the modular device system (100). Also, the battery serves as an uninterrupted power supply (UPS). A UPS is provides emergency power to a load if and when the input power source such as, for example, the AC power source (231), fails. IN one example, the DC power module may be optional.

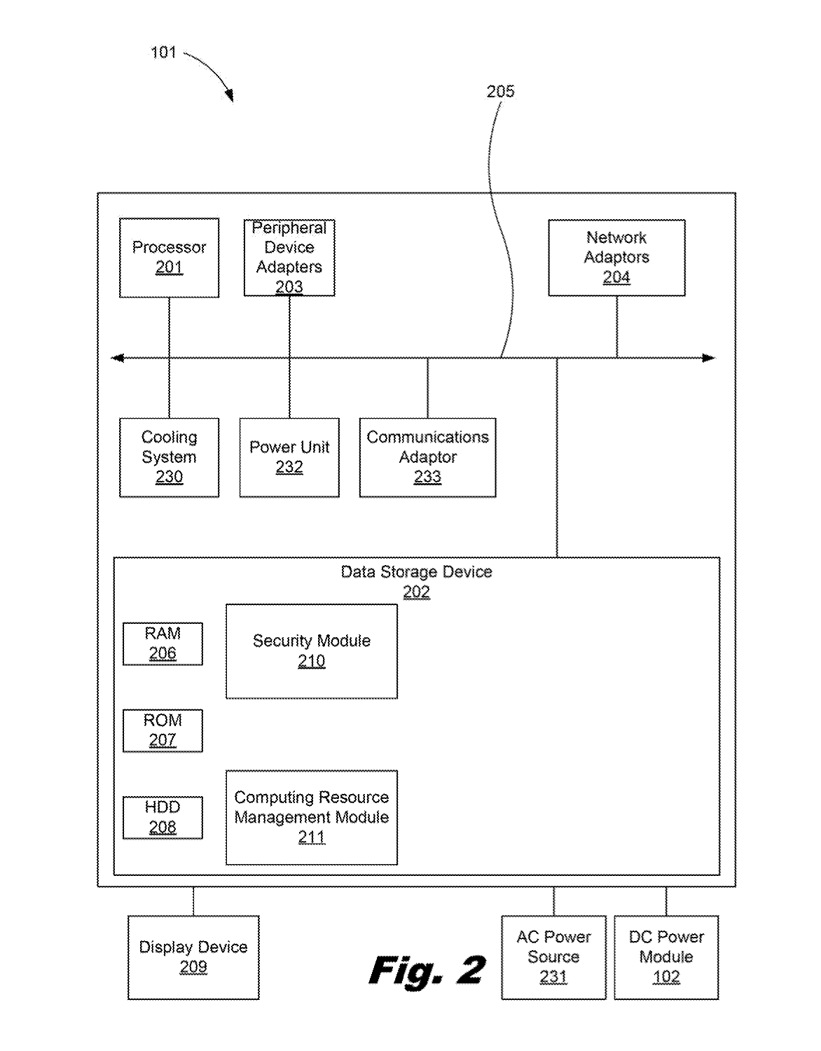

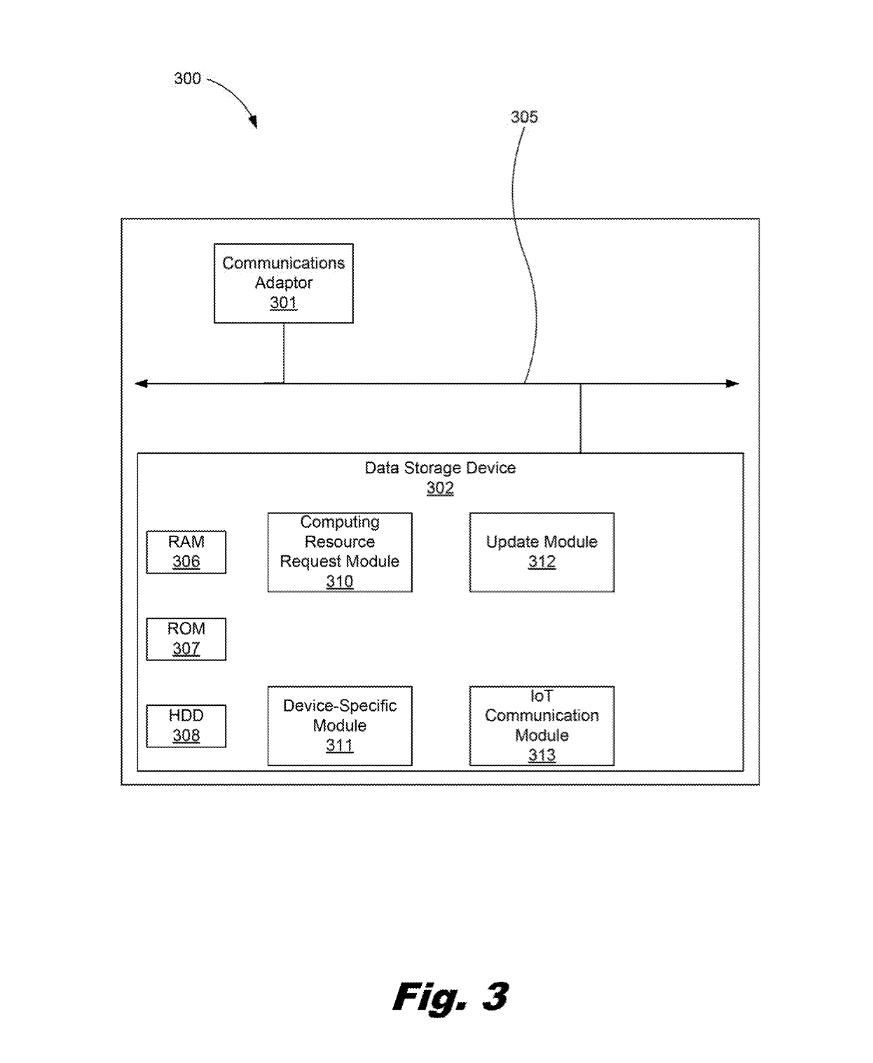

The master module (101) and device modules (103, 104, 105, 106) will now be described in connection with FIGS. 2 and 3, respectively. FIG. 2 is a diagram of the master module (101) of FIG. 1, according to one example of the principles described herein. The master module (101) may be implemented in an electronic device. Examples of electronic devices include servers, desktop computers, laptop computers, personal digital assistants (PDAs), mobile devices, smartphones, gaming systems, and tablets, among other electronic devices.

The master module (101) may be utilized in any data processing scenario including, stand-alone hardware, mobile applications, through a computing network, or combinations thereof. Further, the master module (101) may be used in a computing network, a public cloud network, a private cloud network, a hybrid cloud network, other forms of networks, or combinations thereof. In one example, the methods provided by the master module (101) are provided as a service over a network by, for example, a third party. In this example, the service may comprise, for example, the following: a Software as a Service (SaaS) hosting a number of applications; a Platform as a Service (PaaS) hosting a computing platform comprising, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the master module (101) are executed by a local administrator.

The master module (101) provides computing resources for use by the device modules (103, 104, 105, 106). Thus, to achieve its desired functionality, the master module (101) comprises various hardware components. Among these hardware components may be a number of processors (201), a number of data storage devices (202), a number of peripheral device adapters (203), a number of network adapters (204), a cooling system (230), a power unit (232), and a communications adapter (233). These hardware components may be interconnected through the use of a number of busses and/or network connections. In one example, the processor (201), data storage device (202), peripheral device adapters (203), and a network adapter (204) may be communicatively coupled via a bus (205).

The processor (201) may include the hardware architecture to retrieve executable code from the data storage device (202) and execute the executable code. The executable code may, when executed by the processor (201), cause the processor (201) to implement at least the functionality of providing a number of computational resources to the device modules (103, 104, 105, 106), according to the methods of the present specification described herein. In the course of executing code, the processor (201) may receive input from and provide output to a number of the remaining hardware units.

The data storage device (202) may store data such as executable program code that is executed by the processor (201) or other processing device. As will be discussed, the data storage device (202) may specifically store computer code representing a number of applications that the processor (201) executes to implement at least the functionality described herein.

The data storage device (202) may include various types of memory modules, including volatile and nonvolatile memory. For example, the data storage device (202) of the present example includes Random Access Memory (RAM) (206), Read Only Memory (ROM) (207), and Hard Disk Drive (HDD) memory (208). Many other types of memory may also be utilized, and the present specification contemplates the use of many varying type(s) of memory in the data storage device (202) as may suit a particular application of the principles described herein. In certain examples, different types of memory in the data storage device (202) may be used for different data storage needs. For example, in certain examples the processor (201) may boot from Read Only Memory (ROM) (207), maintain nonvolatile storage in the Hard Disk Drive (HDD) memory (208), and execute program code stored in Random Access Memory (RAM) (206).

Generally, the data storage device (202) may comprise a computer readable medium, a computer readable storage medium, or a non-transitory computer readable medium, among others. For example, the data storage device (202) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters (103, 104) in the master module (101) enable the processor (201) to interface with various other hardware elements, external and internal to the master module (101). For example, the peripheral device adapters (203) may provide an interface to input/output devices, such as, for example, display device (209), a mouse, or a keyboard. The peripheral device adapters (203) may also provide access to other external devices such as an external storage device, a number of network devices such as, for example, servers, switches, and routers, client devices, other types of computing devices, and combinations thereof. In one example, device adapters (203) provide a number of methods of user interfacing to a user. In this example, each of the device modules (103, 104, 105, 106) may be controlled by a user and interacted with in bringing about their individual functionalities as will be described in more detail below.

The display device (209) may be provided to allow a user of the master module (101) to interact with and implement the functionality of the master module (101). The peripheral device adapters (203) may also create an interface between the processor (201) and the display device (209), a printer, or other media output devices. The network adapter (204) may provide an interface to other computing devices within, for example, a network, thereby enabling the transmission of data between the master module (101) and other devices located within the network. In one example, the network adapter (204) provides access to a network such as the Internet for the device modules (103, 104, 105, 106). In this example, the each of the device modules (103, 104, 105, 106) may access resources over the network in bringing about their individual functionalities as will be described in more detail below.

The network adapter (204) may provide an interface to a number of network types including, for example, any network type that supports any Open Systems Interconnection (OSI) model standardized communication type, any network type that supports any Institute of Electrical and Electronics Engineers (IEEE) standardized communication type, BLUETOOTH communication types developed by the Bluetooth Special Interest Group. Ethernet communication types, and WI-FI communication types as defined by the Wi-Fi Alliance, among many other types of communications and their respective types of networks.

The master module (101) may, when executed by the processor (201), display the number of graphical user interfaces (GUIs) on the display device (209) associated with the executable program code representing the number of applications stored on the data storage device (202) and the executable program code representing the number of applications stored on the individual device modules (103, 104, 105, 106). The GUIs may include aspects of the executable code including executable code that assists a user in interacting with the individual device modules (103, 104, 105, 106) to bring about their respective functionalities and executable code that assists a user in interacting with the master module (101) to control various computing resources consumed by the individual device modules (103, 104, 105, 106). The GUIs may display, for example, interactive selectable options that, when selected via a number of interactive gestures, cause the individual device modules (103, 104, 105, 106) and the master module (101) to perform functions described herein. Examples of display devices (209) include a computer screen, a laptop screen, a mobile device screen, a personal digital assistant (PDA) screen, and a tablet screen, among other display devices (209).

The master module (101) further comprises the cooling system (230) for controlling the operating temperatures of the master module (101) and the device modules (103, 104, 105, 106). The cooling system (230) may comprise a number of fans, a number of heat sinks, a number of heat pipes, and a number of fluid pumps, to assist in the cooling the master module (101) and the device modules (103, 104, 105, 106).

The power unit (232) of the master module (101) may control and/or convert power obtained from the DC power module (102) and the AC power source. In one example, the power unit (232) controls the conversion of AC power obtained from the AC power source (231), and provides electrical current to the master module (101) and the device modules (103, 104, 105, 106). In another example, the power unit (231) provides electrical power to the female communication connectors (140, 141, 142, 143, 144, 145) and male communication connectors (146, 147, 148, 149, 150) because these communication ports may have electrical requirements such as requirements for a maximum amount of current. In another example, electrical current is provided through the female power connectors (120, 121, 122, 123, 124, 125) and corresponding male power connectors (126, 127, 128, 129, 130).

The communications adapter (233) provides communication between the master module (101), the DC power module (102), and the device modules (103, 104, 105, 106) by interfacing with the female communication connectors (140, 141, 142, 143, 144, 145) and male communication connectors (146, 147, 148, 149, 150) directly or indirectly throughout the modular device system (100). Thus, signals sent from the DC power module (102), and any of the device modules (103, 104, 105, 106) may be received at the master module (101), and managed and processed by the communications adapter (233).

The master module (101) further comprises a number of modules used in the implementation of provisioning of a number of computational resources to the device modules (103, 104, 105, 106). The various modules within the master module (101) comprise executable program code that may be executed separately. In this example, the various modules may be stored as separate computer program products. In another example, the various modules within the master module (101) may be combined within a number of computer program products; each computer program product comprising a number of the modules.

The master module (101) may include a security module (210) to, when executed by the processor (201), provide security to the master module (101) and the device modules (103, 104, 105, 106). The security module (210) may include a hardware-based network security system such as a firewall to control incoming and outgoing network traffic and protect the master module (101) and device modules (103, 104, 105, 106) from threats from a public network or other source. Thus, the operating system executed on the master module (101) protects the master module (101) and device modules (103, 104, 105, 106) from security vulnerability.

The master module (101) may also include a computing resource management module (211) to, when executed by the processor (201), manage the computing resources of the master module (101) provided to the device modules (103, 104, 105, 106). The computing resource management module (211) provides computation power to the device modules (103, 104, 105, 106) through the processor (201). In one example, the processor's (201) resources are divided among the device modules (103, 104, 105, 106) using virtual machine emulation. With the computing resource management module (211) of master module (101) manage computing resources, the individual device modules (103, 104, 105, 106) can focus on their respective core functionalities rather than attempting to implement all the computing resources individually.

The computing resource management module (211) of master module (101) also manages access to user-data such as user identity, current user location, and user preferences. Management of this information provides for data analytics in association with the master module (101) and the device modules (103, 104, 105, 106). The data analytics may include, for example, inspecting, cleaning, transforming, and modeling data with the goal of discovering useful information, suggesting conclusions, and supporting decision-making.

The computing resource management module (211) also manages access to larger networks, such an internet or the Internet. Thus, access may be restricted or allowed by the computing resource management module (211) of the master module (101) for a number of reasons.

As described above in connection with the power unit (232), the computing resource management module (211), in connection with the power unit (232), manages electrical power provided throughout the system (100) including the master module (101) and the device modules (103, 104, 105, 106). This removes need of separate power lines for each device module (103, 104, 105, 106) simplifying the modular device system (100) and providing a more user-friendly and aesthetically pleasing and cleaner look.

The computing resource management module (211) of the master module (101) also provides plug-and-play functionality with respect to the addition and removal of device modules (103, 104, 105, 106) from the modular device system (100). Thus, the computing resource management module (211) provides for the ability to add device modules (103, 104, 105, 106) seamlessly on a need-basis with a specification that facilitates the discovery of the device modules (103, 104, 105, 106) in the modular device system (100) without the need for physical device configuration or user intervention in resolving resource conflicts.

The computing resource management module (211) may also provide an “always-on” characteristic within the modular device system (100). Thus, the computing resource management module (211) provides a high availability of resources to the device modules (103, 104, 105, 106) by monitoring relevant components within the modular device system (100), determining computing resource requirements of the device modules (103, 104, 105, 106) and procuring those resources, avoiding network failures, avoiding internal application failures, avoiding external services that fail, monitoring the physical environment in which the modular device system (100) is implemented, ensuring storage redundancy, and ensuring network redundancy, among many other aspects of providing high availability of computing resources.

FIG. 3 is a diagram of a device module (103, 104, 105, 106) of FIG. 1, according to one example of the principles described herein. A single example of a device module (103, 104, 105, 106) is depicted in FIG. 3, and described here. However, apart from application specific modules incorporated into the number of device modules (103, 104, 105, 106), the device modules (103, 104, 105, 106) utilized within the module device system (100) are identical.

The device module (103, 104, 105, 106) may be implemented as an electronic device with approximately identical physical dimensions relative to the master module (101). For example, a housing of the device module (103, 104, 105, 106) may comprise approximately identical physical dimensions as the housing of the master module (101). Further, the placement of the female power connector (120, 121, 122, 123, 124, 125), male power connectors (126, 127, 128, 129, 130), female communication connectors (140, 141, 142, 143, 144, 145), and male communication connectors (146, 147, 148, 149, 150) are approximately identical to the placement of the same on the master module (101) so that the connectors align. In this manner, irrespective of the function of the device module (103, 104, 105, 106), the device module (103, 104, 105, 106) may interface with the master module (101) and other device modules (103, 104, 105, 106) within the stack of the module device system (100).

The device module (103, 104, 105, 106) may be utilized in any data processing scenario including, stand-alone hardware, mobile applications, through a computing network, or combinations thereof. Further, the device module (103, 104, 105, 106) may be used in a computing network, a public cloud network, a private cloud network, a hybrid cloud network, other forms of networks, or combinations thereof. In one example, the methods provided by the device module (103, 104, 105, 106) are provided as a service over a network by, for example, a third party. In this example, the service may comprise, for example, the following: a Software as a Service (SaaS) hosting a number of applications; a Platform as a Service (PaaS) hosting a computing platform comprising, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the device module (103, 104, 105, 106) are executed by a local administrator.

To achieve its desired functionality, the device module (103, 104, 105, 106) comprises various hardware components. Among these hardware components may be a communications adaptor (301), and a number of data storage devices (302). These hardware components may be interconnected through the use of a number of busses and/or network connections. In one example, the communications adaptor (301), and data storage devices (302) may be communicatively coupled via a bus (305).

The communications adapter (301) provides communication between the device module (103, 104, 105, 106) and the master module (101) by interfacing with the female communication connectors (140, 141, 142, 143, 144, 145) and male communication connectors (146, 147, 148, 149, 150) directly or indirectly throughout the modular device system (100) and in a similar manner as described above in connection with the communications adapter (233) of the master module (101). Thus, signals may be transmitted by way of the communications adapter (301) of the device module (103, 104, 105, 106) or from any of the device modules (103, 104, 105, 106) within the module device system (100), and received at the master module (101) and managed and processed by the communications adapter (233). In this manner, the device modules (103, 104, 105, 106) may communicate with the master module (101).

The data storage device (302) may store data such as executable program code that is executed by the processor (201) of the master module (101) or other processing device. As will be discussed, the data storage device (302) may specifically store computer code representing a number of applications that the processor (201) executes to implement at least the functionality described herein.

The data storage device (302) may include various types of memory modules, including volatile and nonvolatile memory. For example, the data storage device (302) of the present example includes Random Access Memory (RAM) (306), Read Only Memory (ROM) (307), and Hard Disk Drive (HDD) memory (308). Many other types of memory may also be utilized, and the present specification contemplates the use of many varying type(s) of memory in the data storage device (302) as may suit a particular application of the principles described herein. In certain examples, different types of memory in the data storage device (302) may be used for different data storage needs. For example, in certain examples the processor (201) may maintain nonvolatile storage in the Hard Disk Drive (HDD) memory (308) or Read Only Memory (ROM) (307), and execute program code stored in Random Access Memory (RAM) (306).

Generally, the data storage device (302) may comprise a computer readable medium, a computer readable storage medium, or a non-transitory computer readable medium, among others. For example, the data storage device (302) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The device module (103, 104, 105, 106) further comprises a number of modules used in the implementation of functionality specific to the device module (103, 104, 105, 106). The various modules within the device module (103, 104, 105, 106) comprise executable program code that may be executed separately. In this example, the various modules may be stored as separate computer program products. In another example, the various modules within the device module (103, 104, 105, 106) may be combined within a number of computer program products; each computer program product comprising a number of the modules.

The device module (103, 104, 105, 106) may include a computing resource request module (310) to, when executed by the processor (101), send a communication to the master module (101) requesting use of computing resources within the master module (101). The master module (101) may then provide processing, storage, network connectivity, and other resources to the device module (103, 104, 105, 106) according to the request and based on the execution of executable code within the device module (103, 104, 105, 106).

The device module (103, 104, 105, 106) may further include a device-specific module (311) to, when executed by the processor (101), execute executable code stored in the data storage device (302) pursuant to the functions of the device module (103, 104, 105, 106). As described above, Internet of Things (IoT) refers to identifiable electronic devices and their respective virtual representations in an internet or internet-like structure.

The device modules (103, 104, 105, 106) are devices that provide specific services or functions to the user. For example, the device-specific module (311) of a device module (103, 104, 105, 106) may provide services and functionality associated with a number of electrical systems within the user's home such as home security systems, fire alarms, and smoke detector systems, among others. In this example, the user may interact with the device module (103, 104, 105, 106) via the master module (101) the computing resources provided by the master module (101). The user may, for example, be able to activate an alarm associated with the home security system provided by the device module (103, 104, 105, 106). In doing so, the user may interact with the display device (209), and other input devices associated with the master module (101) and request interaction with the device-specific module (311) within the device module (103, 104, 105, 106). The device module (103, 104, 105, 106) may then send information to the master module (101) for display on the display device (209). This information sent from the device module (103, 104, 105, 106) may include a graphical user interface (GUI) specific to the executable code stored as the device-specific module (311). The user may be presented with a number of interactive selections to modify or manipulate the device module (103, 104, 105, 106) to, in this example, activate the home security system. In this manner, the device module (103, 104, 105, 106) is able to provide specific services and functionality.

This relationship between the master module (101) and the device modules (103, 104, 105, 106) provides for a number of different third party vendors to offer to a user a module that is associated with the third party vendor's services. In keeping with the above home security system example, a company that offers home security services may produce a device module (103, 104, 105, 106) that functions to assist a user in manipulating the user's home security system.

In another example, a home appliance such as, for example, a refrigerator may be an IoT enabled device. In this example, a third party refrigerator manufacturer or even an unrelated third party may develop a device module (103, 104, 105, 106) that allows a user, via the master module (101) and the device module (103, 104, 105, 106) to adjust a number of settings of the refrigerator. For example, the device module (103, 104, 105, 106) in this example may inform a user that a filter in the refrigerator needs replacing.

In still another example, a vehicle or a number of sub-systems may be an IoT enabled device. In this example, a third party vehicle manufacturer or even an unrelated third party may develop a device module (103, 104, 105, 106) that allows a user, via the master module (101) and the device module (103, 104, 105, 106) to adjust a number of settings of the vehicle. For example, a user may be able to turn on the vehicle remotely, or unlock the vehicle if he or she locked the keys inside.

Other examples of application of the master module (101) and device modules (103, 104, 105, 106) may include video gaming console modules, Internet-enabled television modules, video projector modules, home entertainment systems, audio speaker modules, web camera modules, modem and Wi-Fi router modules, external hard-disk modules, voice-over IP (VOIP) telephone modules, among many other modules. Thus, the modular device system (100) provides unlimited possibilities for a vast range of devices connected to the IoT. The device modules (103, 104, 105, 106) consume the computing resources such as CPU cycles, Internet access, user-data access, security resources, and firewalls, among others provided by the master module (101). Thus, the modular device system (100) may be considered a computing-as-a-utility model for IoT devices.

In one example, a license to make, use, sell, and offer for sale a device module (103, 104, 105, 106) that comprises the portions of or the entirety of the technology described herein may be issued to the third party vendor. With this license, the third party vendor may then produce and sell a device module (103, 104, 105, 106) that provides additional functionality and services in association with the services and functionality of the IoT enabled device.

The device module (103, 104, 105, 106) may further include an update module (311) to, when executed by the processor (101), update executable code stored in the data storage device (302). The master module (101) may provide access to an update source such as a website offering a downloadable version of the update or data stored on a local disk drive or memory device. In this manner, the functions and services provided by the device module (103, 104, 105, 106) to the user may be updated by updating executable code within the data storage device (302) of the device module (103, 104, 105, 106). In one example, the updated executable code may be obtained from a vendor. In this example, the vendor may be the same vendor that produced the device module (103, 104, 105, 106).

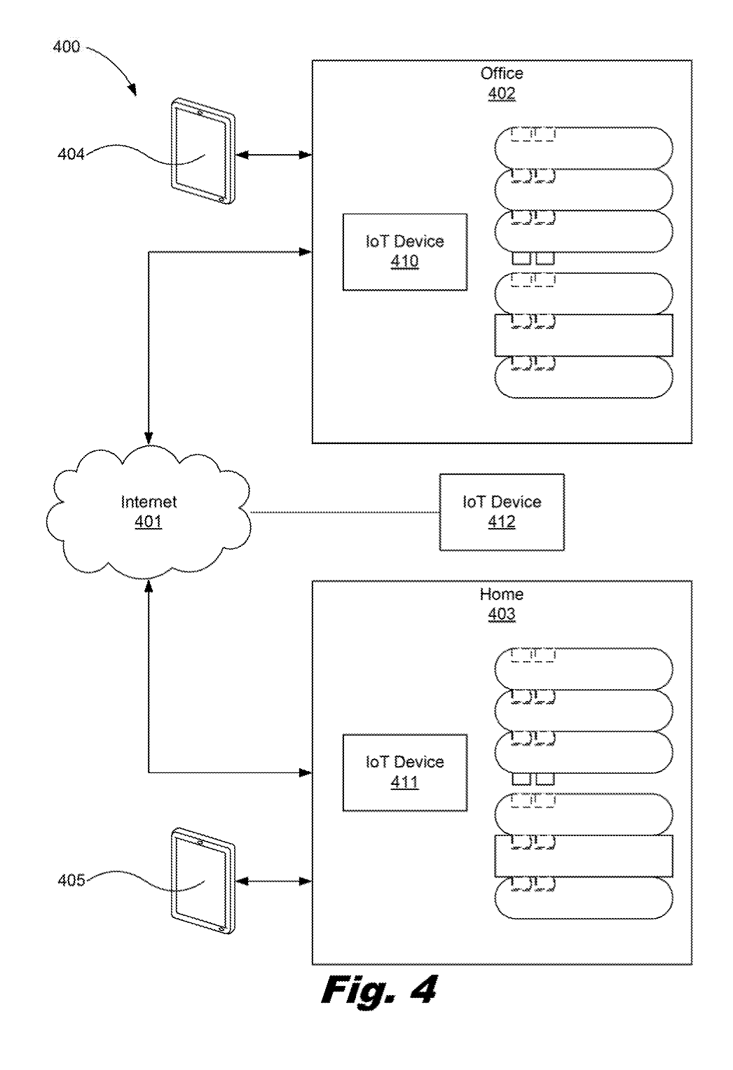

FIG. 4 is a diagram of the two modular device systems (402, 403) of FIG. 1 used in a computing network (400), according to one example of the principles described herein. The computing network (400) may comprise an office modular device system (402) and a home modular device system (403) communicatively coupled to each other via the Internet (401). In this manner, the office modular device system (402) may communicate with and/or control the home modular device system (403), and visa versa. This enables a user to utilize device modules (103, 104, 105, 106) of a separate modular device system (402, 403) to control the IoT devices (410, 411, 412).

Also, as depicted in FIG. 4, a number of mobile computing devices (404, 405) may be communicatively coupled to the modular device systems (402, 403) so as to provide mobile access to a number of device modules (103, 104, 105, 106) included in the modular device systems (402, 403). This may prove user-friendly in situations where a user wishes to adjust a number of IoT devices (410, 411, 412) in their office (402), home (403) or other location such as, for example, a heating and cooling thermostat, a security system, or a starter for a vehicle. A user may do so via the mobile computing devices (404, 405) from a location remote with respect to the modular device systems (402, 403), the office location (402), the home location (403), the IoT devices (410, 411, 412) for which the device modules (103, 104, 105, 106) are installed in the modular device systems (402, 403), other locations, or combinations thereof.

In one example, the device modules (103, 104, 105, 106) directly communicate with their respective IoT devices (410, 411, 412) directly using the IoT communication module (313). The device modules (103, 104, 105, 106) communicate with the master module (101) and vice versa using the communication mechanism described above. In one example, the communication between IoT devices (410, 411, 412) and their respective device modules (103, 104, 105, 106) may be via a wireless network. These wireless networks may comprise any of the wireless technologies described herein including BLUETOOTH communication types developed by the Bluetooth Special Interest Group, WI-FI communication types as defined by the Wi-Fi Alliance, Bluetooth low energy marketed as BLUETOOTH SMART wireless personal area network technology designed and marketed by the Bluetooth Special Interest Group, ZIGBEE communication protocols developed by the ZigBee Alliance, among many other wireless technologies.

In one example, the master module (101) communicates only to the device modules (103, 104, 105, 106), and not to the IoT devices (410, 411, 412) directly. In this example, vendors may implement their own proprietary communication protocols between a device module (103, 104, 105, 106) they produce, and their respective IoT devices (410, 411, 412).

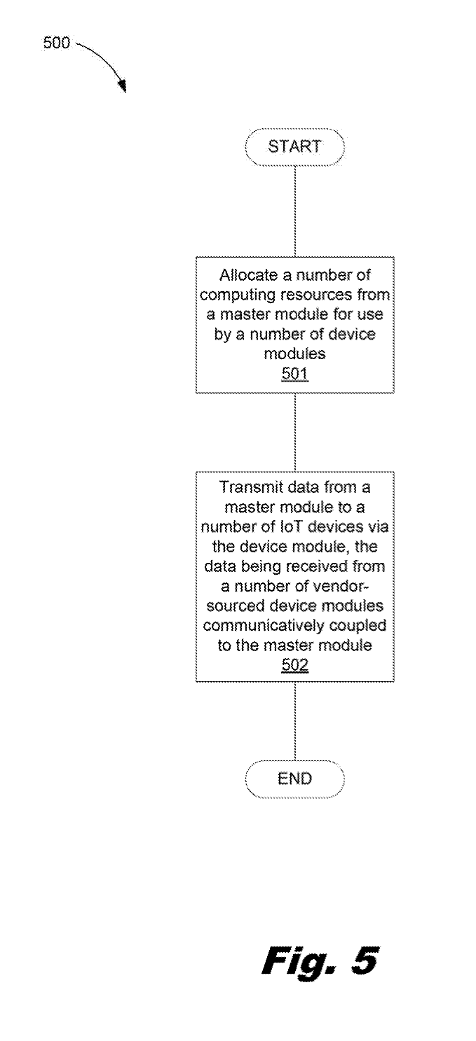

FIG. 5 is a flowchart showing a method (500) of providing access to an internet-of-things (IoT) device, according to one example of the principles described herein. The method (500) may include allocating (block 501) a number of computing resources from a master module (101) for use by a number of device modules (103, 104, 105, 106). As described above, processing power, data storage, communications, and other computing resources may be divided among a number of device modules (103, 104, 105, 106) using virtual machine emulation, for example.

The master module (101) may transmit (block 502) data to a number of internet-of-things devices (410, 411, 412) via the device modules (103, 104, 105, 106). The data is received from the device modules (103, 104, 105, 106) communicatively coupled to the master module (101) using the above described communication couplings. In one example, the device modules (103, 104, 105, 106) may be vendor-sourced device modules. In this example, the vendors are entities that provide services associated with the internet-of-things device.

The method (500) of FIG. 5 may further comprise licensing technology regarding the master module (101) to a vendor in order for the vendor to produce or manufacture a device module (103, 104, 105, 106) that functions, in association with the master module (101), to manipulate an internet-of-things device (410, 411, 412). The method (500) may further comprise selling the device modules (103, 104, 105, 106) separate from the master module (101).

Thus, the present modular device system (100) provides for a centralized command-and-control architecture for IoT devices. The end sensors or devices are distributed across various locations, but the master module (101) acts as a separate command and control module through which the number of device modules (103, 104, 105, 106) are controlled. Thus, in this distributed systems architecture, the commands and control are handled by a single trusted entity found in the master module (101). Further, the device modules (103, 104, 105, 106) are physically located in a single stack and within a single footprint. This provides extensibility, stackability, and ease of manageability for a user. Still further, the aesthetics of the modular device system (100) is increased as may be desired in a home or office application.

Further, all user preferences, identities, and other privacy elements of the user are available in a central location in the data storage device (202) of the master module (101). This avoids distribution of critical and sensitive private data to untrusted devices. Also, the device modules (103, 104, 105, 106) may behave in accordance with changing user preferences automatically. Still further, data analytics may be streamlined due to the master module (101) being in receipt of and storing all data from the device modules (103, 104, 105, 106).

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (201) of the master module (101) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe master module that includes a processor and a memory. The memory includes executable code that, when executed by the processor, provides a number of computational resources to a number of device modules. The device modules are vendor-sourced device modules. The vendors are entities that provide services associated with an internet-of-things device. This master module may have a number of advantages, including: (1) eliminating the need to replace outdate systems and devices, (2) providing a standardized IoT system, (3) creating a single module system that exists within a single horizontal footprint resulting in a lower cost to the user and an aesthetically pleasing system, (4) providing modularization of external computing devices and peripherals, (5) provides for a user's continually changing IoT needs, and (6) provides extensibility among the device modules, among other advantages.

The preceding description has been presented to illustrate and describe examples of the principles described. This description is not intended to be exhaustive or to limit these principles to any precise form disclosed. Many modifications and variations are possible in light of the above teaching.

What is claimed is:

1. A master module, comprising:
a processor;
a memory, the memory comprising executable code that, when executed by the processor:
provides a number of computational resources to a number of device modules,
in which the device modules are vendor-sourced device modules, and
in which the vendors are entities that provide services associated with an internet-of-things device.

2. The master module of claim 1, in which the computational resources comprise electrical power, processing power, data storage, network connectivity, security, or combinations thereof.

3. The master module of claim 1, in which the vendor-sourced device modules provide functionality associated with an internet-of-things device.

4. The master module of claim 1, in which the master module further comprises a number of data connections for transfer of data between the device modules.

5. The master module of claim 4, in which the device modules comprise:
a number of data input connections for receiving data from the master module or other device modules; and
a number of data output connections for transmitting data to the master module or other device modules.

6. The master module of claim 1, in which the master module further comprises a number of electrical connections for transfer of electrical power between the device modules.

7. The master module of claim 1, in which the device modules are communicatively stackable on the master module and other device modules.

8. A method of providing access to an internet-of-things device, comprising:
allocating a number of computing resources from a master module for use by a number of device modules; and
transmitting data from the master module to a number of internet-of-things devices via the device modules, the data being received from the device modules communicatively coupled to the master module,
in which the device modules are vendor-sourced device modules, and
in which the vendors are entities that provide services associated with the internet-of-things device.

9. The method of claim 8, further comprising licensing technology regarding the master module to a vendor.

10. The method of claim 8, further comprising selling the device modules separate from the master module.

11. A computer program product for controlling an internet-of-things device, the computer program product comprising:
a computer readable storage medium comprising computer usable program code embodied therewith, the computer usable program code comprising:
computer usable program code to, when executed by a processor, receive data from a vendor-sourced device module communicatively coupled to the master module, the data comprising instructions to control the internet-of-things device; and
computer usable program code to, when executed by a processor, transmit data to the internet-of-things device.

12. The computer program product of claim 11, further comprising:
computer usable program code to, when executed by a processor, update computer code stored within the vendor-sourced device module.

13. The computer program product of claim 12, further comprising computer usable program code to, when executed by a processor, obtain data associated with updating computer code stored within the vendor-sourced device module from the vendor.

14. The computer program product of claim 11, further comprising computer usable program code to, when executed by a processor, provide a number of computational resources to the device module.

15. The computer program product of claim 14, further comprising computer usable program code to, when executed by a processor, provide the computational resources to the device module as a virtual machine emulation.
